(19) United States
(12) Patent Application Publication
(10) Pub. No.: US 2019/0026408 A1
(43) Pub. Date: Jan. 24, 2019

(54) PEOPLE FLOW SIMULATION APPARATUS AND METHOD

(71) Applicant: FUJITSU LIMITED, Kawasaki-shi (JP)

(72) Inventors: Masashi Yamaumi, Kawasaki (JP); Takuro Ikeda, Yokohama (JP); Taizo ANAN, Kawasaki (JP)

(73) Assignee: FUJITSU LIMITED, Kawasaki-shi (JP)

(21) Appl. No.: 16/033,853

(22) Filed: Jul. 12, 2018

(30) Foreign Application Priority Data
Jul. 19, 2017 (JP) 2017-140341

(51) Int. Cl. G06F 17/50; G06N 7/00; G06Q 10/06

(52) U.S. Cl. CPC G06F 17/5009; G06Q 10/063; G06N 7/005

(57) ABSTRACT

A people flow simulation apparatus includes a memory configured to store incentive information and effect characteristic information in association with a plurality of person models, the incentive information indicating incentive provided for each of the plurality of person models, the effect characteristic information indicating each of characteristics of effects that the incentive has on each of the plurality of persons models, and a processor coupled to the memory and the processor configured to calculate probabilities with which a first person model goes to each of a plurality of places on the basis of first incentive information and first effect characteristic information associated with the first person model included in the plurality of person models, and select, from among the plurality of places, a first place as a destination to which the first person model goes in accordance with the calculated probabilities.

### CROSS-REFERENCE TO RELATED APPLICATION

This application is based upon and claims the benefit of priority of the prior Japanese Patent Application No. 2017-140341, filed on Jul. 19, 2017, the entire contents of which are incorporated herein by reference.

### FIELD

The embodiment discussed herein is related to technology for simulating the flow of people.

### BACKGROUND

There are some known techniques associated with the flow of people in a theme park. One of those techniques relates to design of the arrangement and individual positions of facilities in a theme park. In this technique, the movement and stay of visitors, referred to below as the “people flow”, are simulated, and then this simulation result is reflected in the design. Another technique aims to relieve overcrowding in facilities in a theme park without modifying the design of the arrangement and individual positions of facilities. In this technique, priority entry tickets for facilities that could be overcrowded are issued to visitors.

When visitors get priority entry tickets for a desired facility, they tend to first go to another facility and then go to the desired facility. As a result, the visitors are able to use this facility without having to wait a long time. Such priority entry tickets are expected to be a trigger that pushes visitors to take a predetermined action. Moreover, other media, such as discount tickets, vouchers, and coupons for restaurants in the theme park, are also expected to be a trigger.

For example, related techniques are disclosed in Japanese Laid-open Patent Publication No. 06-176004 and Japanese National Publication of International Patent Application No. 2007-509393.

### SUMMARY

According to an aspect of the invention, a people flow simulation apparatus includes a memory configured to store incentive information and effect characteristic information in association with a plurality of person models, the incentive information indicating incentive provided for each of the plurality of person models, the effect characteristic information indicating each of characteristics of effects that the incentive has on each of the plurality of persons models, and a processor coupled to the memory and the processor configured to calculate probabilities with which a first person model goes to each of a plurality of places on the basis of first incentive information and first effect characteristic information associated with the first person model included in the plurality of person models, and select, from among the plurality of places, a first place as a destination to which the first person model goes in accordance with the calculated probabilities.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates an example of a people flow simulation system;

FIG. 2 illustrates an example of a hardware configuration of the controller;

FIG. 3 is an example of a block diagram of the controller;

FIG. 4 illustrates an example of venue data;

FIG. 5 illustrates an example of facility data;

FIG. 6 illustrates an example of facility program data;

FIG. 7 illustrates an example of route data;

FIG. 8 illustrates an example of visitor data;

FIG. 9 illustrates an example of visitor model data;

FIG. 10A illustrates an example of preference model data;

FIG. 10B illustrates an example of action characteristic model data;

FIG. 10C illustrates an example of effect characteristic model data;

FIG. 11 illustrates an example of a venue table;

FIG. 12 illustrates an example of a facility table;

FIG. 13 illustrates an example of a facility program table;

FIG. 14 illustrates an example of a route table;

FIG. 15 illustrates an example of a visitor table;

FIG. 16 is a flowchart of an example of an operation of the controller;

FIG. 17 illustrates an example of a simulation result of visitor agents;

FIG. 18 illustrates another example of the simulation result of the visitor agents;

FIG. 19 illustrates an example of a simulation result of facility agents;

FIG. 20 illustrates another example of the simulation result of the facility agents;

FIG. 21A illustrates further another example of the simulation result of the facility agents;

FIG. 21B illustrates yet another example of the simulation result of the facility agents;

FIG. 22 is a flowchart of an example of a simulation process;

FIG. 23 illustrates an example of procedures for a state transition process; and

FIG. 24 is a flowchart of an example of a facility selection process.

### DESCRIPTION OF EMBODIMENTS

Some visitors are influenced strongly by media as described above, but others are not. In short, visitors are influenced differently by media and take different actions. Herein, an effect of a medium which has on a visitor is referred below as an “effect characteristic”. However, related techniques do not consider the effect characteristics of individual visitors to simulate a people flow, and thus their simulations may be inaccurate.

Some embodiments will be described below with reference to the accompanying drawings.

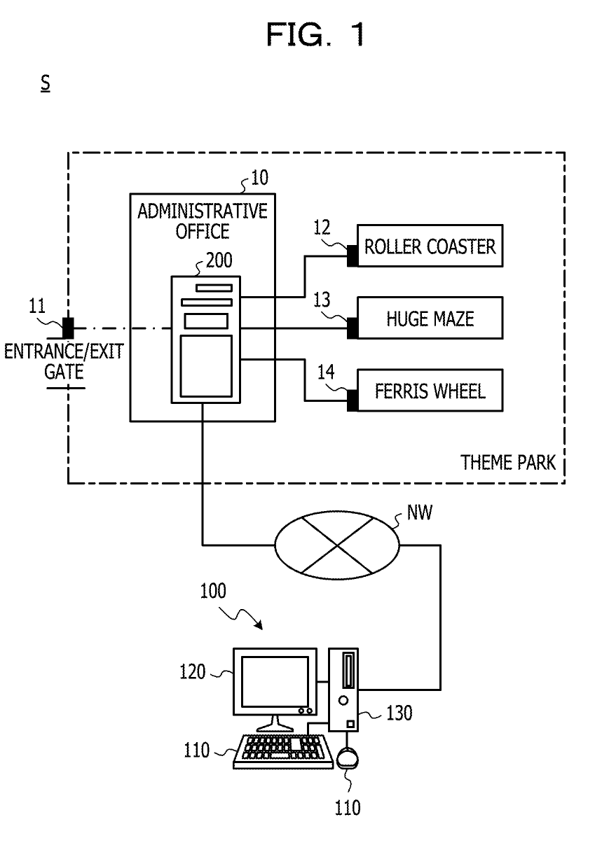

FIG. 1 schematically illustrates an example of a people flow simulation system S, which may be a so-called multi-agent system. This people flow simulation system S includes a terminal device 100 and a server device 200; the terminal device 100 serves as a people flow simulation apparatus. In FIG. 1, a personal computer (PC) is used as an example of the terminal device 100; however, another smart device such as a smartphone or a tablet terminal may be used instead. The terminal device 100 is operated by a user who may be, for example, a person responsible for simulating a people flow in a theme park. It is to be noted that a theme park is an example of a place in which a people flow is to be simulated. As an alternative example, a people flow in a tourist spot or a resort may be simulated. In this embodiment, a description will be given regarding a case where a people flow in a theme park is simulated.

The server device 200 may be installed inside an administrative office 10 in a theme park, for example. The server device 200 is connected to a plurality of sensors 11 to 14. The sensor 11 is connected to an entrance/exit gate and counts the numbers of visitors entering and exiting from the theme park. The sensors 12 to 14 count the numbers of visitors using and waiting to use corresponding attraction facilities, including a roller coaster, a huge maze, and a Ferris wheel. Each of the sensors 12 to 14 has a ticket dispenser that issues priority tickets. Those attraction facilities are referred below simply as the “facilities”. In this embodiment, each of the sensors 12 to 14 separately counts the numbers of visitors waiting in a priority lane and in an ordinary lane; the visitors in the priority lane have priority tickets but visitors in the ordinary lane have no priority tickets. In this way, via the sensors 11 to 14, the server device 200 acquires the total number of visitors in the theme park and the numbers of visitors using and waiting to use the individual facilities. As a result, the server device 200 grasps the congested state of the theme park as well as the congested states of the individual facilities. Alternatively, the server device 200 may grasp the congested states by using a simulation result instead of the sensing results of the sensors 11 to 14. Furthermore, the server device 200 regularly or irregularly generates information on priority tickets in accordance with the congested states. Then, the server device 200 outputs this information to the above ticket dispensers or to the terminal device 100 in response to a request from the terminal device 100, more specifically, from a visitor agent. Details of the visitor agent will be described later. Together with the generated information, the server device 200 may output information that encourages visitors to move to predetermined facilities and information regarding various media such as coupons.

The terminal device 100 is connected to the server device 200. More specifically, the terminal device 100 is connected to the server device 200 via a communication network NW, which may be the Internet, for example. Thus, the terminal device 100 is connected to the server device 200 through wired communication.

The terminal device 100 includes an input unit 110, a display 120, and a controller 130. The controller 130 controls a content to be displayed by the display 120 in accordance with information or an instruction received via the input unit 110. In addition, the controller 130 receives information from the server device 200 in response to the information or instruction received via the input unit 110. Then, the controller 130 uses the received information to control the content in the display 120.

A description will be given below of details of a configuration and operation of the controller 130.

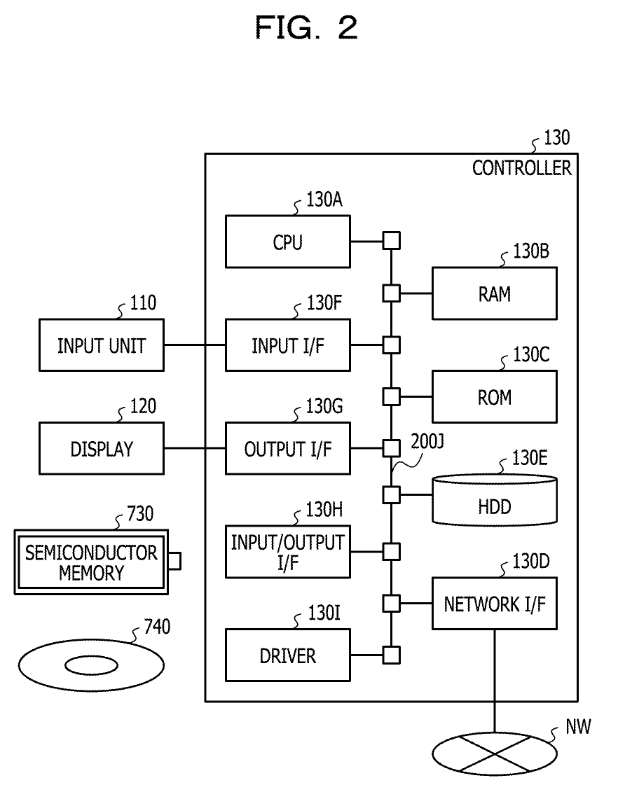

FIG. 2 illustrates an example of a hardware configuration of the controller 130. Since the server device 200 has substantially the same hardware configuration as the controller 130, the hardware configuration of the server device 200 will not be described. As illustrated in FIG. 2, the controller 130 at least includes, as processors, a central processing unit (CPU) 130A, random access memory (RAM) 130B, read only memory (ROM) 130C, and a network interface (I/F) 130D. In addition, the controller 130 may include one or more of a hard disk drive (HDD) 130E, an input I/F 130F, an output I/F 130G, an input/output I/F 130H, and a driver 130I as appropriate. All of the CPU 130A, the RAM 130B, the ROM 130C, the network I/F 130D, the HDD 130E, the input I/F 130F, the output I/F 130G, the HDD 130E, and the driver 130I are interconnected via an internal bus 130J. Of these components, at least the CPU 130A and the RAM 130B collaborate with each other to realize computer functions. Instead of the CPU 130A, the controller 130 may include a micro processing unit (MPU) as a processor.

The input I/F 130F is connected to the input unit 110, which may include a keyboard and a mouse, for example. The output I/F 130G is connected to the display 120, which may be a liquid crystal display, for example. The input/output I/F 130H is connected to a semiconductor memory 730, which may be a universal serial bus (USB) memory or a flash memory, for example. The input/output I/F 130H reads programs and data from the semiconductor memory 730 or writes programs and data into the semiconductor memory 730. For example, each of the input I/F 130F and the input/output I/F 130H may be provided with a USB port, and the output I/F 130G may be provided with a display port.

The driver 130I is able to accommodate a portable recording medium 740, which may be a compact disc read-only memory (CD-ROM), a digital versatile disc (DVD), or other removable disk, for example. The driver 130I reads programs and data from the portable recording medium 740. The network I/F 130D is provided with a LAN port, for example, and connected to the communication network NW.

The CPU 130A reads programs from the ROM 130C and the HDD 130E and stores these programs in the RAM 130B. Likewise, the CPU 130A reads programs from the portable recording medium 740 and stores these programs in the RAM 130B. The CPU 130A executes the programs stored in the RAM 130B, thereby realizing various functions and performing various processes. Details of those operations will be described later. The programs may be executed in accordance with flowcharts that will be referenced later.

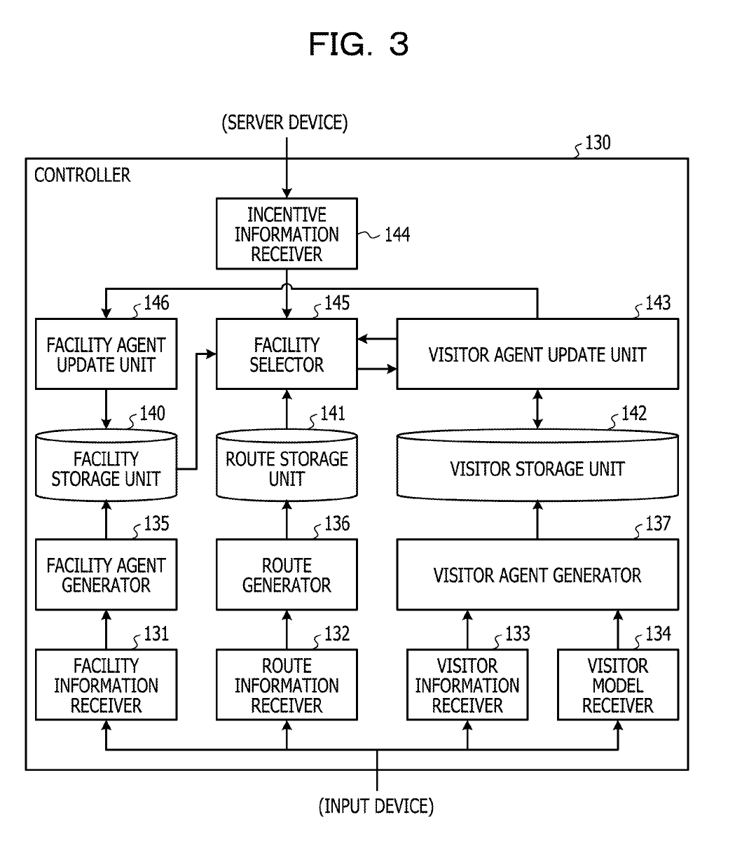

With reference to FIGS. 3 to 15, functions of the controller 130 will be described.

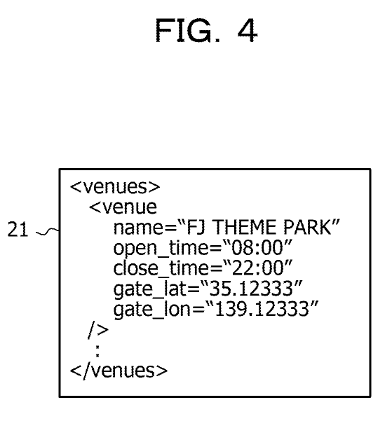

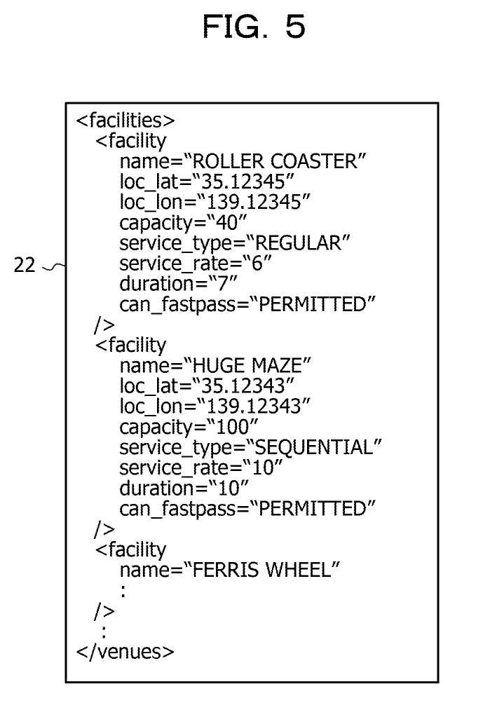

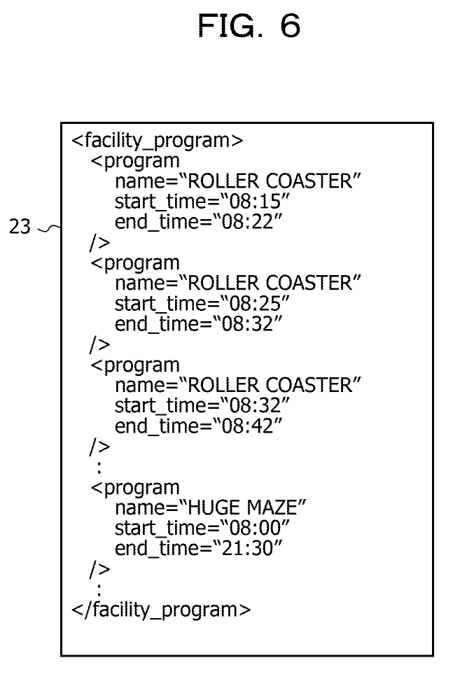

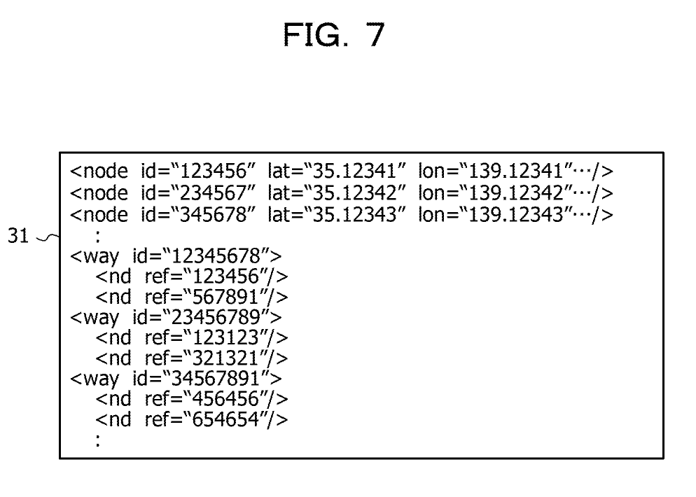

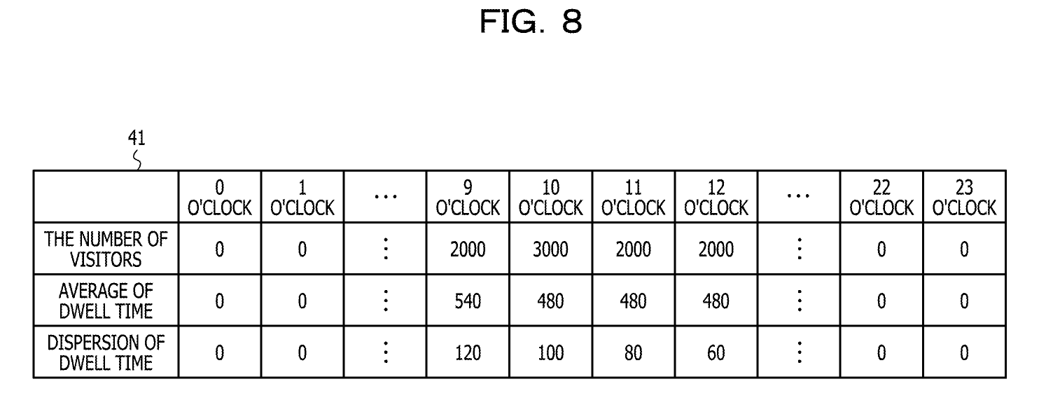

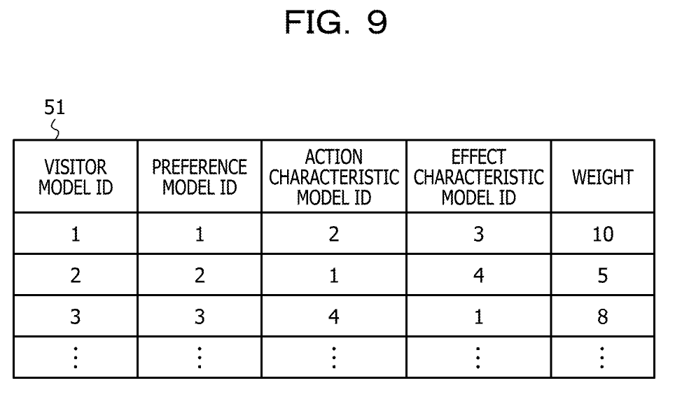

FIG. 3 is an example of a block diagram of the controller 130. More specifically, FIG. 3 schematically illustrates a functional configuration of the controller 130. FIG. 4 illustrates an example of venue data 21; FIG. 5 illustrates an example of facility data 22; FIG. 6 illustrates an example of facility program data 23; FIG. 7 illustrates an example of route data 31; FIG. 8 illustrates an example of visitor data 41; and FIG. 9 illustrates an example of visitor model data 51.

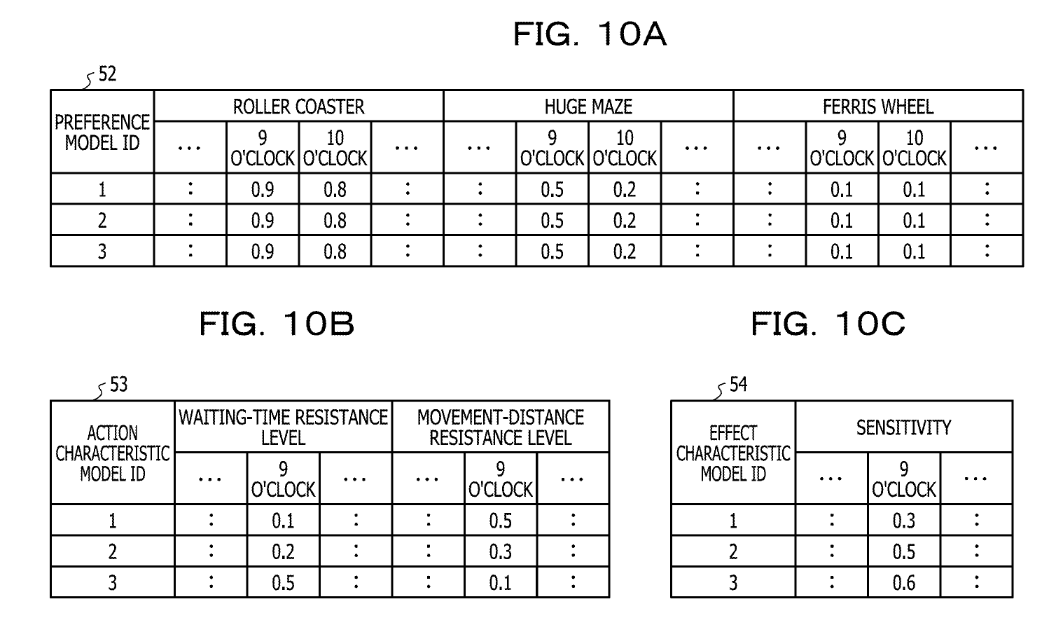

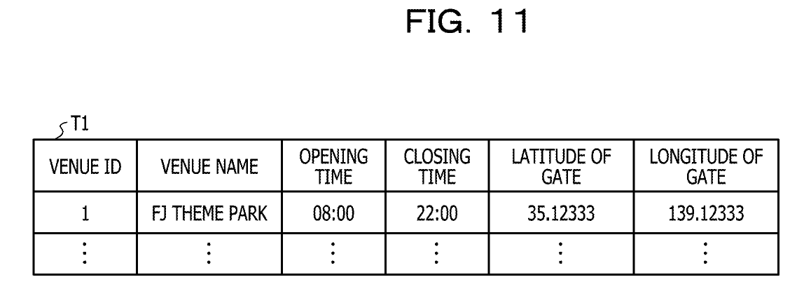

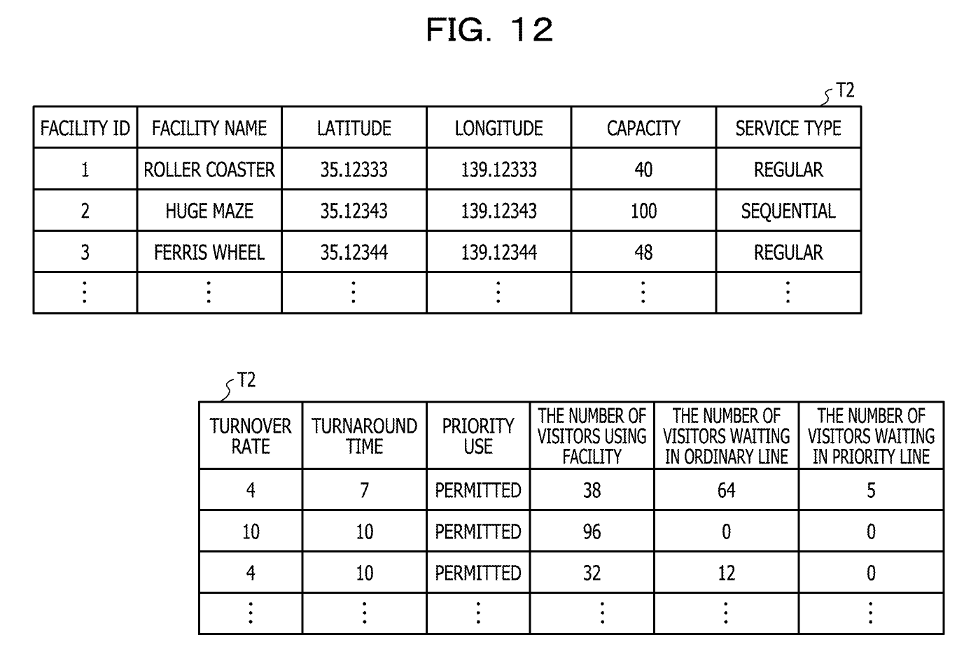

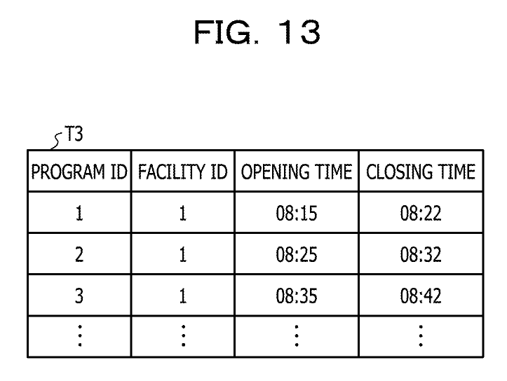

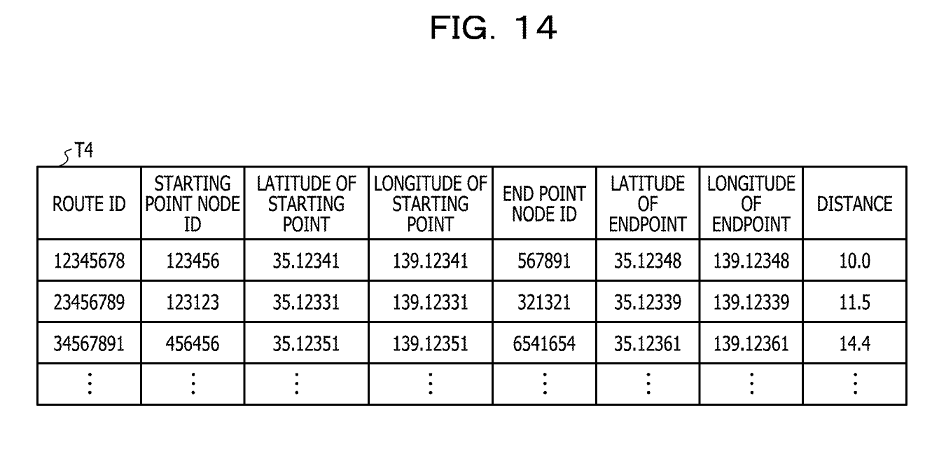

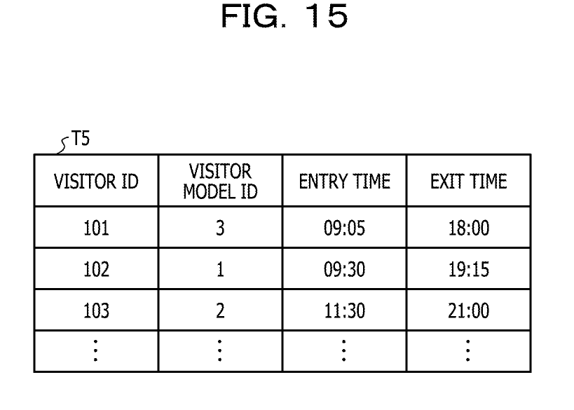

FIG. 10A illustrates an example of preference model data 52; FIG. 10B illustrates an example of action characteristic model data 53; and FIG. 10C illustrates an example of effect characteristic model data 54. FIG. 11 illustrates an example of a venue table T1; FIG. 12 illustrates an example of a facility table T2; FIG. 13 illustrates an example of a facility program table T3; FIG. 14 illustrates an example of a route table T4; and FIG. 15 illustrates an example of a visitor table T5.

As illustrated in FIG. 3, the controller 130 includes a facility information receiver 131, a route information receiver 132, a visitor information receiver 133, and a visitor model receiver 134. The controller 130 further includes a facility agent generator 135, a route generator 136, and a visitor agent generator 137 as processing units. The controller 130 further includes a facility storage unit 140, a route storage unit 141, and a visitor storage unit 142. The controller 130 further includes a visitor agent update unit 143, an incentive information receiver 144, a facility selector 145, and a facility agent update unit 146 as processing units.

For example, the facility information receiver 131, the route information receiver 132, the visitor information receiver 133, and the visitor model receiver 134 may be implemented using the input I/F 130F. The facility storage unit 140, the route storage unit 141, and the visitor storage unit 142 may be implemented using the RAM 130B or the HDD 130E. The facility agent generator 135, the route generator 136, the visitor agent generator 137, the visitor agent update unit 143, the facility selector 145, and the facility agent update unit 146 may be implemented using CPU 130A. The incentive information receiver 144 may be implemented using the network I/F 130D.

The facility information receiver 131 receives facility information via the input unit 110 and then outputs this facility information to the facility agent generator 135. The facility information contains venue data 21, facility data 22, and facility program data 23, which are described with a predetermined description language, as illustrated in FIGS. 4 to 6. The venue data 21 is used to simulate people flows in venues and contains a name, business hour, and location, such as longitude and latitude, of each venue. Herein, the venues corresponds to places. The facility data 22 is related to a plurality of facilities installed in the venues that are specified by the venue data 21 and contains a name, a location, and a capacity of each facility. The facility program data 23 is related to programs provided by the facilities that are specified by the facility data 22 and contains start and end times of the programs. When receiving the facility information containing the venue data 21, the facility data 22, and the facility program data 23, the facility information receiver 131 outputs this facility information to the facility agent generator 135.

The route information receiver 132 receives route information via the input unit 110 and then outputs this route information to the route generator 136. The route information contains route data 31 described with a predetermined description language, as illustrated in FIG. 7. The route data 31 represents routes along which visitors move between the individual facilities. The route data 31 contains: routes ID for use in identifying the routes; starting point nodes ID for use in identifying the starting points of the routes; endpoint nodes ID for use in identifying the endpoints of the routes; and the locations, such as latitudes and longitudes, of the starting points and endpoints. When receiving the route information containing the route data 31, the route information receiver 132 outputs this route information to the route generator 136.

The visitor information receiver 133 receives visitor information via the input unit 110 and then outputs this visitor information to the visitor agent generator 137. The visitor information contains the visitor data 41, as illustrated in FIG. 8. The visitor data 41 contains: the numbers of visitors coming to each venue specified by the venue data 21 in individual time zones; and the averages and dispersions of dwell times of each visitor in the individual time zones. The visitor data 41 may be defined by a spreadsheet application, for example. When receiving the visitor information containing the visitor data 41, the visitor information receiver 133 outputs this visitor information to the visitor agent generator 137.

The visitor model receiver 134 receives visitor model information via the input unit 110. Then, the visitor model receiver 134 outputs the received visitor model information to the visitor agent generator 137. The visitor model information contains the visitor model data 51, the preference model data 52, the action characteristic model data 53, and the effect characteristic model data 54, as illustrated in FIGS. 9 and 10A to 10C. Each of the visitor model data 51, the preference model data 52, the action characteristic model data 53, and the effect characteristic model data 54 may be defined by a spreadsheet application, for example.

The visitor model data 51 is formed by modeling various characteristics of visitors. As illustrated in FIG. 9, the visitor model data 51 contains visitor model IDs, preference model IDs, action characteristic model IDs, effect characteristic model IDs, and weights, as components. The visitor models IDs are identification information for use in identifying the visitor model data 51. The preference model IDs are identification information for use in identifying the preference model data 52. The action characteristic model IDs are identification information for use in identifying the action characteristic model data 53. The effect characteristic model IDs are identification information for use in identifying the effect characteristic model data 54. The weights are used as references when the visitor model IDs are allocated to respective visitor agents, details of which will be described later.

The above preference model data 52 is formed by modeling the preferences of visitors for each facility. As illustrated in FIG. 10A, the preference model data 52 contains parameters related to the respective preference model IDs, and each of these parameters indicates preferences of visitors for individual facilities in time zones. Referring to the row of the preference model data 52 specified by the preference model ID “1”, for example, the parameter of the preference for a roller coaster indicates “0.9” in the time zone of nine, but drops to “0.8” in the time zone of ten. This means that many more visitors like to choose the roller coaster in the time zone of nine than in the time zone of ten. The parameters of the preferences for other facilities are similar to that for the roller coaster. In this way, the preference model data 52 chronologically manages the preferences of visitors for a plurality of facilities in each time zone.

The above action characteristic model data 53 is formed by modeling characteristics of visitors' action. As illustrated in FIG. 10B, the action characteristic model data 53 contains parameters related to the respective action characteristic model IDs, and each of these parameters indicates waiting-time resistance levels and movement-distance resistance levels in time zones, as characteristics of visitors' action. Each of the waiting-time resistance levels represents a resistance level of visitors for waiting; each of the movement-distance resistance levels represents a resistance level of visitors for moving. Herein, the resistance levels correspond to tolerance. Referring to the row of the action characteristic model data 53 specified by the action characteristic model ID “1”, for example, the parameter of the waiting-time resistance level indicates “0.1” in the time zone of nine, and the parameter of the movement-distance resistance levels indicates “0.5” in the time zone of nine. This means that in the time zone of nine, visitors are able to endure waiting to some degree but have difficulty enduring moving. In this way, the action characteristic model data 53 chronologically manages the waiting-time resistance levels and the movement-distance resistance levels in each time zone.

The above effect characteristic model data 54 is formed by modeling characteristics of effects that incentive information has on visitors. This incentive information is used to motivate visitors to take actions. Examples of the incentive information include: information that encourages visitors to move from one facility to another; information on priority tickets, vouchers, discount tickets, and coupons; and other information that motivates visitors to move. The incentive information may be linked to motivational degree, such as a discount rate or service value. As illustrated in FIG. 10C, the effect characteristic model data 54 contains parameters related to the respective effect characteristic model IDs as the characteristics of visitors, and each of the parameters indicates the sensitivities of visitors to the incentive information in time zones. Referring to the row of the effect characteristic model data 54 specified by the effect characteristic model ID “1”, for example, the parameter of the sensitivity indicates “0.3” in the time zone of nine. This means that the visitors are not influenced strongly by the incentive information in the time zone of nine. If the parameter of the sensitivity indicates “0.9”, visitors are influenced strongly by the incentive information. In this way, the effect characteristic model data 54 chronologically manages the sensitivities in each time zone.

The facility agent generator 135 generates facility agents, based on the facility information received from the facility information receiver 131. These facility agents are information that acts as agents of the facilities under a simulation environment. More specifically, as illustrated in FIG. 11, the facility agent generator 135 generates the venue table T1 containing the venue data 21, based on the venue data 21 contained in the received facility information. Then, the facility agent generator 135 registers the generated venue table T1 in the facility storage unit 140. In addition, as illustrated in FIG. 12, the facility agent generator 135 generates the facility table T2 containing the facility data 22, based on the facility data 22 contained in the facility information. Then, the facility agent generator 135 registers the generated facility table T2 in the facility storage unit 140, as the facility agents. Furthermore, as illustrated in FIG. 13, the facility agent generator 135 generates the facility program table T3 containing the facility program data 23, based on the facility program data 23 contained in the facility information. Then, the facility agent generator 135 registers the generated facility program table T3 in the facility storage unit 140.

The route generator 136 generates movement routes for the visitor agents, based on the route information received from the route information receiver 132. More specifically, as illustrated in FIG. 14, the route generator 136 generates the route table T4 containing the route data 31, based on the route data 31 contained in the route information. The route generator 136 registers the generated route table T4 in the route storage unit 141, as the movement routes.

The visitor agent generator 137 generates visitor agents, based on both the visitor information and the visitor model information received from the visitor information receiver 133 and the visitor model receiver 134, respectively. These visitor agents are information that acts as agents of visitors under the simulation environment. More specifically, the visitor agent generator 137 first generates the visitor table T5 as illustrated in FIG. 15, based on the number of visitors and the dispersion of the dwell time for each time zone which are both contained in the visitor information. Then, the visitor agent generator 137 allocates visitor model IDs in the visitor model data 51 to the respective rows in the column “visitor model ID” in the visitor table T5, based on the proportions of the weights (see FIG. 9) contained in the visitor model data 51. The visitor table T5 is thereby related to the preference model data 52 (see FIG. 10A), the action characteristic model data 53 (see FIG. 10B), and the effect characteristic model data 54 (see FIG. 10C) via the visitor model data 51 (see FIG. 9). For example, the preference, action characteristic, and effect characteristic of the visitor ID “101” in FIG. 15 is specified by the visitor model ID “3”. Based on the visitor model data 51 (see FIG. 9), the visitor model ID “3” is specified by the preference model ID “3”, the action characteristic model ID “4”, and the effect characteristic model ID “1”. After having generated the visitor table T5 in this manner, the visitor agent generator 137 registers the generated visitor table T5 in the visitor storage unit 142 as the visitor agents.

The visitor agent update unit 143 updates the states of the visitor agents stored in the visitor storage unit 142 in accordance with the time base of the simulation environment. More specifically, the visitor agent update unit 143 updates the states of all the visitor agents staying in the theme park under the simulation environment. Examples of the states of the visitor agents include a state of moving to a facility, a state of waiting to use a facility, and a state of using a facility. Details of the visitor agents will be described later. After having updated the states of the visitor agents, the visitor agent update unit 143 registers the states of the visitor agents updated in the visitor storage unit 142 as the simulation results. The visitor agent update unit 143 obtains the preference model data 52, the action characteristic model data 53, and the effect characteristic model data 54, based on the visitor model data 51 on the visitor agents. Then, the visitor agent update unit 143 outputs the preference model data 52, the action characteristic model data 53, and the effect characteristic model data 54 to the facility selector 145.

The incentive information receiver 144 receives the incentive information from the server device 200 in accordance with or independently of a request from any visitor agent. When receiving the incentive information, the incentive information receiver 144 outputs this incentive information to the facility selector 145.

The facility selector 145 selects a destination facility for each visitor agent from among the facilities. More specifically, the facility selector 145 obtains the facility agents from the facility storage unit 140 and further obtains the movement routes from the route storage unit 141. After having obtained the facility agents and the movement routes, the facility selector 145 selects the destination facility for each visitor agent from among the facilities, based on the facility agents and movement routes, the preference model data 52 received from the visitor agent update unit 143, the action characteristic model data 53 received from the visitor agent update unit 143, the effect characteristic model data 54 received from the visitor agent update unit 143, and the incentive information received from the incentive information receiver 144. After having selected the destination facilities for the respective visitor agents, the facility selector 145 registers the selected destination facilities to the visitor storage unit 142 via the visitor agent update unit 143.

The facility agent update unit 146 updates the facility agents stored in the facility storage unit 140. More specifically, the facility agent update unit 146 updates the facility agents, based on the state, such as an in-use or waiting state, of each visitor agent at the time of the simulation. As an example, if many more visitors are waiting to ride on the roller coaster than those at the time of the previous simulation, the facility agent update unit 146 increases the number of visitors waiting to ride on the roller coaster. As another example, if many more visitors are riding on the roller coaster than those at the time of the previous simulation, the facility agent update unit 146 increases the number of visitors riding on the roller coaster. Then, the facility agent update unit 146 registers the result of updating the facility agents in the facility storage unit 140 as the simulation result.

Next, an operation of the controller 130 will be described below.

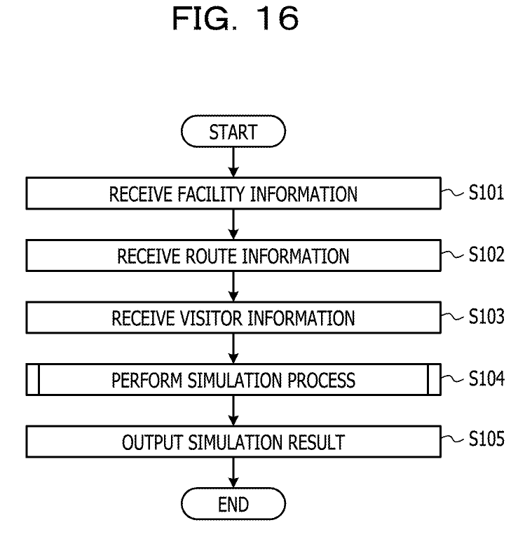

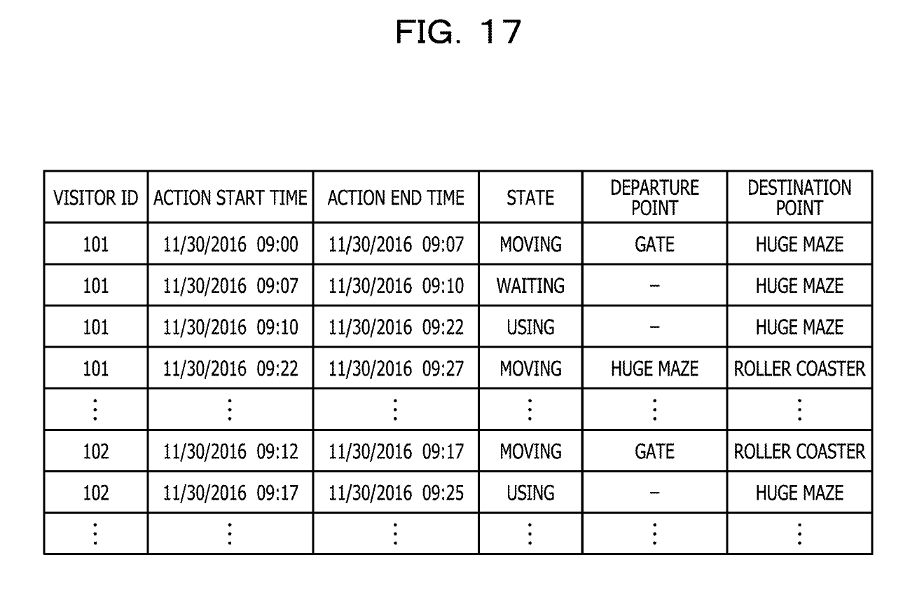

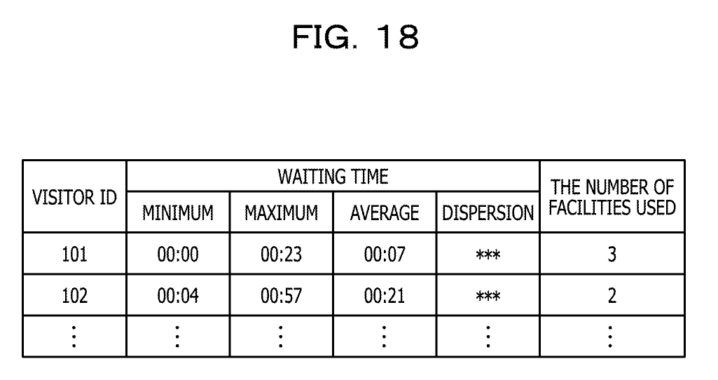

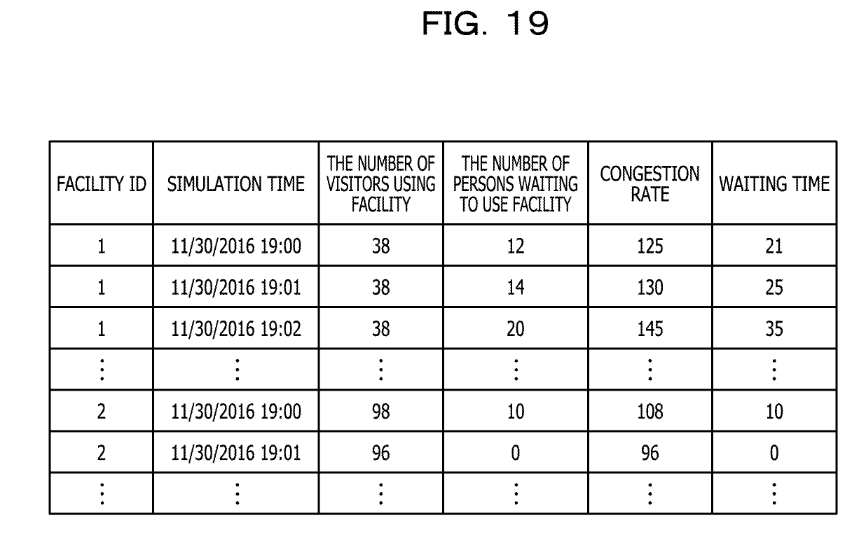

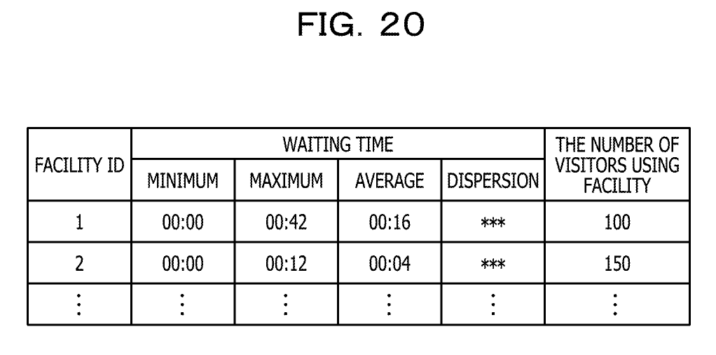

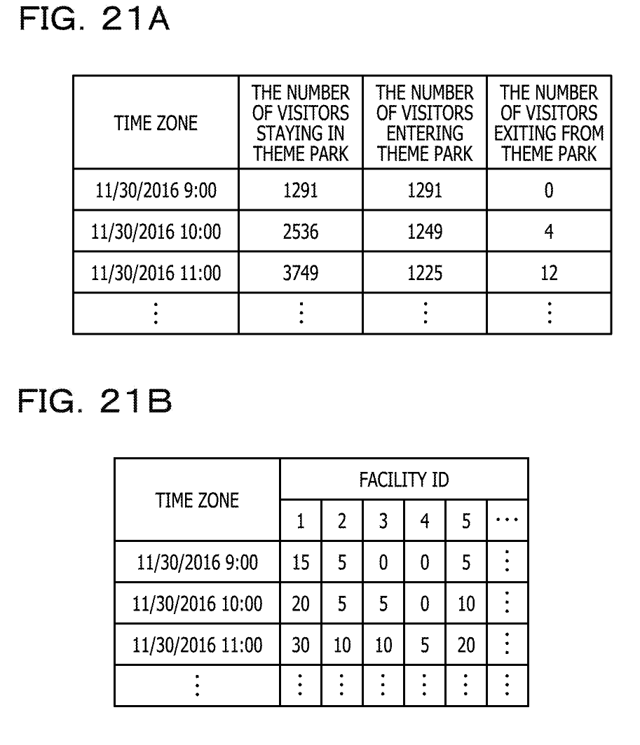

FIG. 16 is a flowchart of an example of an operation of the controller 130; FIG. 17 illustrates an example of a simulation result of the visitor agents; FIG. 18 illustrates another example of the simulation result of the visitor agents; FIG. 19 illustrates an example of a simulation result of the facility agents; FIG. 20 illustrates another example of the simulation result of the facility agents; FIG. 21A illustrates further another example of the simulation result of the facility agents; and FIG. 21B illustrates yet another example of the simulation result of the facility agents.

At Step S101, the facility information receiver 131 receives the facility information via the input unit 110. At Step S102, the route information receiver 132 receives the route information via the input unit 110. At Step S103, the visitor information receiver 133 receives the visitor information via the input unit 110. More specifically, the visitor information receiver 133 receives the visitor information via the input unit 110, and the visitor model receiver 134 receives the visitor model information via the input unit 110.

After the completion of Step S103, at Step S104, the facility agent generator 135 to the facility agent update unit 146 perform the simulation process. In this simulation process, more specifically, the facility agent generator 135, the route generator 136, and the visitor agent generator 137 generate the facility agents, the movement routes, and the visitor agents, respectively. Based on the generated facility agents, movement routes, and visitor agents as well as the received incentive information, then, the visitor agent update unit 143 and the facility agent update unit 146 update the states of the visitor agents and the facility agents, respectively. The simulation process corresponds to a process of simulating a people flow, details of which will be described later.

After the completion of Step S104, at Step S105, the visitor agent update unit 143 and the facility agent update unit 146 output simulation results. As an example, the visitor agent update unit 143 may output the simulation result of the visitor agents to the visitor storage unit 142. As another example, the facility agent update unit 146 may output the simulation result of the facility agents to the facility storage unit 140.

Examples of the simulation result of the visitor agents which is output to the visitor storage unit 142 include: action histories of the visitor agents with the visitor IDs as illustrated in FIG. 17; and waiting times of the visitor agents with the visitor IDs as illustrated in FIG. 18. Examples of the simulation result of the facility agents which is output to the facility storage unit 140 include: the numbers of visitors using and waiting to use the facility agents with the facility IDs and congestion rates and waiting times in the facility agents with the facility IDs at individual simulation times as illustrated in FIG. 19; and waiting times in the facility agents with the facility IDs as illustrated in FIG. 20. Other examples of the simulation result of the facility agents which is output to the facility storage unit 140 include: the number of visitors staying within the theme park in each time zone as illustrated in FIG. 21A; and average waiting times within facilities in each time zone as illustrated in FIG. 21B. The visitor agent update unit 143 and the facility agent update unit 146 may output those simulation results to the display 120. The number of visitors waiting to use each facility agent may be the number of visitors waiting in either the ordinary or priority lane. FIG. 19 illustrates the numbers of visitors waiting in the ordinary or primary lane, both of which are output to the facility storage unit 140. The congestion rate of a certain facility agent may be obtained by dividing the sum of the numbers of visitors using the facility agent and waiting to use the facility agent by the capacity of the facility agent. The waiting time of a certain facility agent may be obtained by dividing the number of visitors waiting to use the facility agent by a turnover rate of the facility agent and then multiplying the resultant value by a turnaround time of the facility agent. The numbers of visitors waiting to use facility agents and the congestion rates and the waiting times in the facility agents are calculated by the facility agent update unit 146.

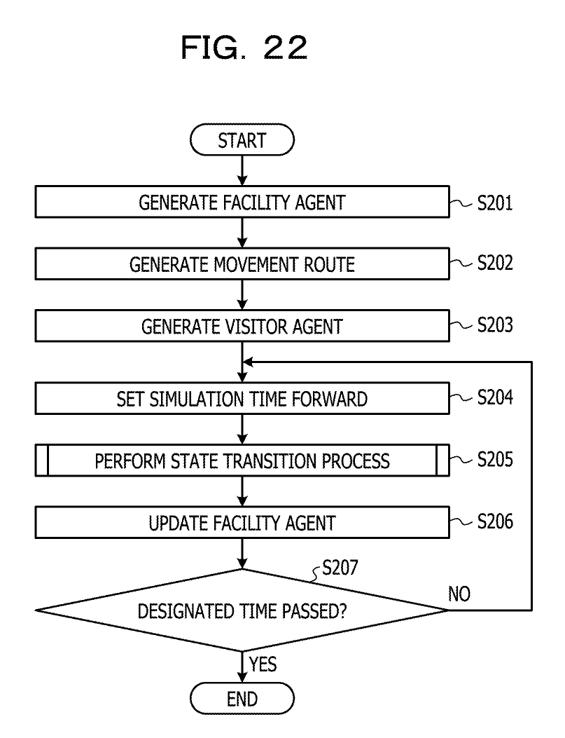

With reference to FIG. 22, the above simulation process will be described in detail.

FIG. 22 is a flowchart of an example of the simulation process. After the completion of Step S103 in FIG. 16, at Step S201, the facility agent generator 135 generates the facility agents. At Step S202, the route generator 136 generates the movement routes. At Step S203, the visitor agent generator 137 generates the visitor agents.

After the completion of Step S203, at Step S204, the visitor agent update unit 143 sets a simulation time forward by one step, such as one minute. At Step S205, the visitor agent update unit 143 performs a state transition process, which is a process for transiting from a state of a visitor agent to another and selecting a destination facility for the visitor agent. Details of the state transition process will be described later.

After the completion of Step S205, at Step S206, the facility agent update unit 146 updates the facility agents. At Step S207, the visitor agent update unit 143 determines whether a designated time has passed. When it is determined that the designated time has not yet passed (No at Step S207), the visitor agent update unit 143 performs Step S204 again. In short, every time the simulation time is set forward, the visitor agent update unit 143 updates the states of the visitor and facility agents. When it is determined that the designated time has already passed (Yes at Step S207), the visitor agent update unit 143 concludes the simulation process.

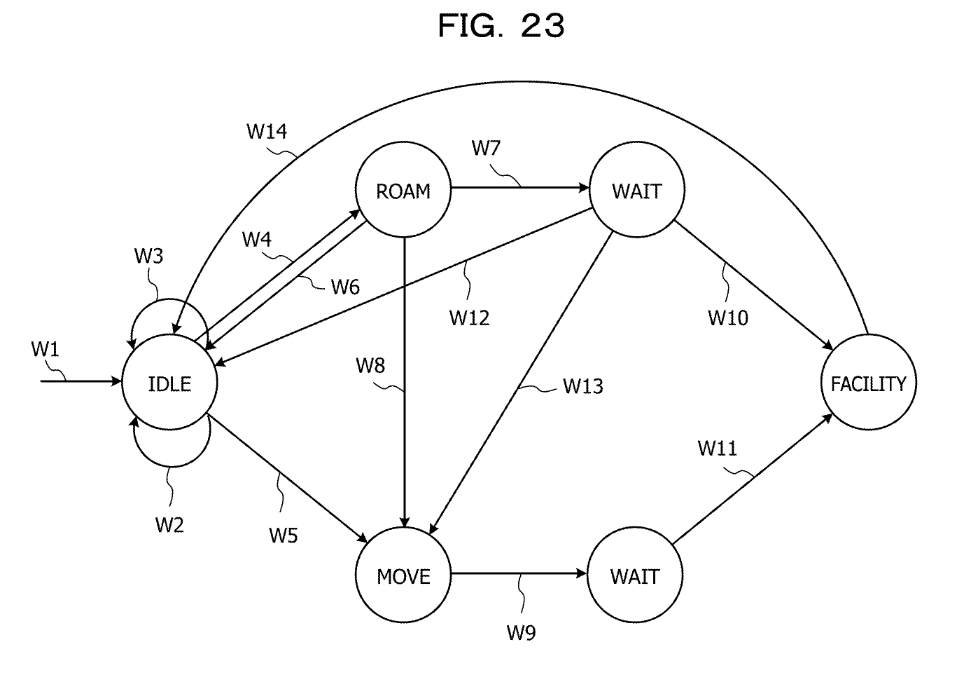

FIG. 23 illustrates an example of procedures for the state transition process. More specifically, FIG. 23 schematically illustrates the transition of states of a visitor agent in the theme park. First, the visitor agent generator 137 generates a visitor agent, which then enters the theme park and transits to an idle state at W1. In this case, with a probability p1, the visitor agent selects a destination facility to go. With a probability p2, which is a fixed value defined in advance, the visitor agent asks the server device 200 to recommend some destination facilities from at W2. With probability 1-p₁-p₂, the visitor agent remains in the idle state at W3. Details of the process of selecting the destination facility will be described later.

When selecting the destination facility, the visitor agent transits from the idle state to a roaming state at W4. As a result, the visitor agent starts walking toward the selected destination facility. Alternatively, if the visitor agent asks the server device 200 to recommend some destination facilities from at W2, the visitor agent obtains a plurality of destination facilities recommended and their priority tickets with preset valid times. Then, the visitor agent selects one from among the plurality of destination facilities recommended. If the priority ticket for the selected destination facility which the visitor agent has obtained when being in the idle state is usable, namely, it is possible to reach the selected destination facility until the valid time has passed, the visitor agent transits from the idle state to the moving state at W5. Thus, the visitor agent moves toward the destination facility.

After having transited to the roaming state at W4, the visitor agent moves toward the destination facility. When the visitor agent reaches the destination facility, the visitor agent update unit 143 determines whether to enter a waiting state. In this case, if the visitor agent waits a considerably long time, the visitor agent update unit 143 determines that the visitor agent gives up using the destination facility. For example, if the waiting time exceeds a preset time, the visitor agent transits from the roaming state to the idle state at W6. If the waiting time is shorter than the preset time, the visitor agent transits from the roaming state to the waiting state at W7. In this case, the visitor agent does not have the priority ticket, and waits in the ordinary lane accordingly.

If the visitor agent obtains the priority ticket after having transited to the roaming state at W4 and determines that it is difficult to reach the destination facility until the valid time has passed, the visitor agent transits from the roaming state to the moving state at W8. For example, this determination may be made based on a movement route obtained by the visitor agent update unit 143.

After having transited to the moving state, the visitor agent moves toward the destination facility for which priority ticket is usable. When reaching the destination facility, the visitor agent transits from the moving state to the waiting state at W9. In this case, the visitor agent has the priority ticket, and waits in the priority lane accordingly.

Regardless of whether the visitor agent is in the ordinary or priority lane, the visitor agent remains in the waiting state waits until a time when the visitor agent is permitted to use the destination facility comes. When this time comes, the visitor agent transits from the waiting state to a facility usage state at W10 or W11. If the visitor agent is waiting in the ordinary lane, the visitor agent update unit 143 may determine whether to enter the waiting state under a stricter condition than if the visitor agent is in the roaming state. If the waiting time is longer than a preset time, for example, the visitor agent may leave the line with a predetermined probability and then transit from the waiting state to the idle state at W12. If the visitor agent obtains the priority ticket after having transited to the waiting state at W7 and determines that it is difficult to reach the facility within the valid time, the visitor agent transits from the waiting state to the moving state at W13.

After having transited to the facility usage state at W10 or W11, the visitor agent is using the facility. When finishing using the facility, the visitor agent transits from the facility usage state to the idle state at W14. After having stayed in the theme park over a preset dwell time, the controller 130 terminates the simulation of the visitor agent.

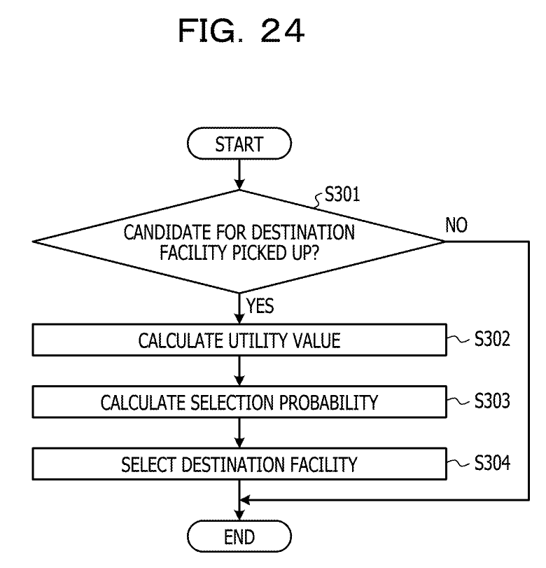

FIG. 24 is a flowchart of an example of a facility selection process. This facility selection process is performed when the visitor agent selects a destination facility from among destination facilities recommended by the server device 200. At Step S301, first, the facility selector 145 determines whether it is possible to pick up some candidates for a destination facility. More specifically, when the visitor agent transits to the above idle state, the facility selector 145 determines whether it is possible to pick up some facility agents that have not been used by the visitor agent. If the visitor agent already uses the facility agents of all the facilities installed in the theme park, the facility selector 145 determines that it is impossible to pick up any unused facility (No at Step S301), and then concludes the facility selection process.

If the visitor agent has not yet used by the facility agents of all the facilities, the facility selector 145 determines that it is possible to pick up one or more unused facility agents (Yes at Step S301). At Step S302, then, the facility selector 145 calculates utility values of the unused facility agents. In this embodiment, the facility selector 145 calculates a utility value Vᵢ(t) of each facility agent at a time t by using equation (1) and coefficients described below.

Vᵢ(t)=Pᵢ(t)−β₁(t)WTᵢ−β₂(t)Dᵢ+β₃(t)Iᵢ (1)

Pᵢ denotes preference for facility agent i.

WTᵢ denotes waiting time in facility agent i.

Dᵢ denotes distance to facility agent i.

Iᵢ denotes strength of information or incentive regarding facility agent i.

β₁ denotes resistance level for waiting time.

β₂ denotes resistance level for movement distance.

β₃ denotes sensitivity to information or incentive.

The facility selector 145 designates only recommended destination facilities whose utility values are equal to or more than a predetermined value, as candidates for the destination facility.

After the completion of Step S302, at Step S303, the facility selector 145 calculates selection probabilities of the facility agents. In this embodiment, the facility selector 145 calculates selection probability Probᵢ(t) of the facility agent i at the time t by using the calculated utility values of the facility agents and equation (2) described below.

$${Prob}_{i} ( t ) = \frac{exp ( {V}_{i} ( t ) )}{{\sum }_{j ∈ A} exp ( {V}_{j} ( t ) )} \qquad ( 2 )$$

Wherein A denotes candidates for destination facility.

After the completion of Step S303, at Step S304, the facility selector 145 selects the destination facility from the candidates. More specifically, the facility selector 145 selects the destination facility, based on the selection probabilities Probᵢ(t) of the facility agents. For example, the facility selector 145 may select, from among the facility agents whose selection probabilities Probᵢ(t) have been calculated, the facility agent having the maximum selection probability Probᵢ(t). Then, the facility selector 145 may designate the selected facility agent as the destination facility. In short, the facility selector 145 sets the above probability P₁ to the maximum selection probability Probᵢ(t), and designates the facility with the probability P₁ as the destination facility. After the completion of Step S304, the facility selector 145 concludes the facility selection process. In this way, the facility selector 145 calculates utility values of facility agents in consideration of an effect characteristic of a visitor agent. Then, the facility selector 145 calculates selection probabilities of facilities, based on the calculated utility values, and selects a destination facility from the facilities, based on the calculated selection probabilities.

According to this embodiment, as described above, a controller 130 includes a visitor agent generator 137 and a facility selector 145. The visitor agent generator 137 generates a plurality of visitor agents under a simulation environment, based on visitor information and a plurality of pieces of effect characteristic model information, so that visitor agents are linked to the respective pieces of effect characteristic model information. Using the pieces of effect characteristic model information and equation (2), then, the facility selector 145 selects, from among the plurality of facility agents generated under the simulation environment, destination facility agents to which the respective visitor agents will go. In this way, the controller 130 successfully simulates a people flow in consideration of visitors' effect characteristics.

Some unlimited embodiments have been described. However, such embodiments may undergo various modifications and variations within the scope of the claims. As one example, although the action characteristic model information used in the foregoing embodiment represents resistance levels of a visitor for a waiting time and a movement distance, this action characteristic model information may represent resistance levels of a visitor for weather, environment such as temperature or humidity, or a population density of the theme park.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A people flow simulation apparatus comprising:
a memory configured to store incentive information and effect characteristic information in association with a plurality of person models, the incentive information indicating incentive provided for each of the plurality of person models, the effect characteristic information indicating each of characteristics of effects that the incentive has on each of the plurality of persons models; and
a processor coupled to the memory and the processor configured to
calculate probabilities with which a first person model goes to each of a plurality of places on the basis of first incentive information and first effect characteristic information associated with the first person model included in the plurality of person models, and
select, from among the plurality of places, a first place as a destination to which the first person model goes in accordance with the calculated probabilities.

2. The people flow simulation apparatus according to claim 1, wherein
the memory is configured to further store action characteristic information that indicates tolerance of each of the plurality of person models to at least one of a waiting time and a movement distance, and
the probabilities are calculated on the basis of first action characteristic information associated with the first person model and at least one of the waiting time and the movement distance regarding each of the plurality of places.

3. The people flow simulation apparatus according to claim 1, wherein
the memory is configured to further store preference information that indicates ease with which each of the plurality of places is selected, and
the probabilities are calculated on the basis of the preference information.

4. The people flow simulation apparatus according to claim 1, wherein
the effect characteristic information is stored in association with each period of time, and
the probabilities are calculated on the basis of the first effect characteristic information associated with a first period corresponding to time information.

5. The people flow simulation apparatus according to claim 1, wherein the characteristics of the effects indicates ease with which destinations to which the person models go are changed in accordance with the incentive information.

6. The people flow simulation apparatus according to claim 1, wherein the incentive encourages each of the person models to go to a specific place among the plurality of places.

7. A computer-implemented people flow simulation method comprising:
referring to a memory configured to store incentive information and effect characteristic information in association with a plurality of person models, the incentive information indicating incentive provided for each of the plurality of person models, the effect characteristic information indicating each of characteristics of effects that the incentive has on each of the plurality of persons models;
calculating probabilities with which a first person model goes to each of a plurality of places on the basis of first incentive information and first effect characteristic information associated with the first person model included in the plurality of person models; and
selecting, from among the plurality of places, a first place as a destination to which the first person model goes in accordance with the calculated probabilities.

8. The people flow simulation method according to claim 7, wherein
the memory is configured to further store action characteristic information that indicates tolerance of each of the plurality of person models to at least one of a waiting time and a movement distance, and
the probabilities are calculated on the basis of first action characteristic information associated with the first person model and at least one of the waiting time and the movement distance regarding each of the plurality of places.

9. The people flow simulation method according to claim 7, wherein
the memory is configured to further store preference information that indicates ease with which each of the plurality of places is selected, and
the probabilities are calculated on the basis of the preference information.

10. The people flow simulation method according to claim 7, wherein
the effect characteristic information is stored in association with each period of time, and
the probabilities are calculated on the basis of the first effect characteristic information associated with a first period corresponding to time information.

11. The people flow simulation method according to claim 7, wherein the characteristics of the effects indicates ease with which destinations to which the person models go are changed in accordance with the incentive information.

12. The people flow simulation method according to claim 7, wherein the incentive encourages each of the person models to go to a specific place among the plurality of places.

13. A non-transitory computer-readable medium storing a people flow simulation program that causes a computer to execute a process comprising:
referring to a memory configured to store incentive information and effect characteristic information in association with a plurality of person models, the incentive information indicating incentive provided for each of the plurality of person models, the effect characteristic information indicating each of characteristics of effects that the incentive has on each of the plurality of persons models;
calculating probabilities with which a first person model goes to each of a plurality of places on the basis of first incentive information and first effect characteristic information associated with the first person model included in the plurality of person models; and
selecting, from among the plurality of places, a first place as a destination to which the first person model goes in accordance with the calculated probabilities.

14. The medium according to claim 13, wherein
the memory is configured to further store action characteristic information that indicates tolerance of each of the plurality of person models to at least one of a waiting time and a movement distance, and
the probabilities are calculated on the basis of first action characteristic information associated with the first person model and at least one of the waiting time and the movement distance regarding each of the plurality of places.

15. The medium according to claim 13, wherein
the memory is configured to further store preference information that indicates ease with which each of the plurality of places is selected, and
the probabilities are calculated on the basis of the preference information.

16. The medium according to claim 13, wherein
the effect characteristic information is stored in association with each period of time, and
the probabilities are calculated on the basis of the first effect characteristic information associated with a first period corresponding to time information.

17. The medium according to claim 13, wherein the characteristics of the effects indicates ease with which destinations to which the person models go are changed in accordance with the incentive information.

18. The medium according to claim 13, wherein the incentive encourages each of the person models to go to a specific place among the plurality of places.
